(19) United States
(12) Patent Application Publication
(10) Pub. No.: US 2012/0243798 A1
(43) Pub. Date: Sep. 27, 2012

(54) IMAGE PROCESSING APPARATUS, IMAGE PROCESSING METHOD, AND NON-TRANSITORY COMPUTER READABLE MEDIUM STORING IMAGE PROCESSING PROGRAM

(75) Inventors: Taro YOKOSE, Kanagawa (JP); Tomoki TANIGUCHI, Kanagawa (JP)

(73) Assignee: FUJI XEROX CO., LTD., Tokyo (JP)

(21) Appl. No.: 13/247,558

(22) Filed: Sep. 28, 2011

(30) Foreign Application Priority Data
Mar. 25, 2011 (JP) 2011-067507

(51) Int. Cl. G06K 9/36

(52) U.S. Cl. 382/233; 382/232

(57) ABSTRACT

An image processing apparatus includes an image receiving unit receiving an image, a conversion unit converting the received image, a separation unit separating the converted image into pixel synchronization information and pixel asynchronization information, a first encoding unit encoding the pixel synchronization information, a second encoding unit encoding the pixel asynchronization information, a first decoding unit decoding a code encoded by the first encoding unit to generate the pixel synchronization information, a second decoding unit decoding a code encoded by the second encoding unit to generate the pixel asynchronization information, a synthesis unit synthesizing the decoded pixel synchronization information with the decoded pixel asynchronization information on the basis of the pixel synchronization information, a reverse conversion unit performing a conversion process reverse to the conversion process of the conversion unit on the synthesized information, and an output unit outputting the image converted by the reverse conversion unit.

### CROSS-REFERENCE TO RELATED APPLICATIONS

This application is based on and claims priority under 35 USC 119 from Japanese Patent Application No. 2011-067507 filed Mar. 25, 2011.

### BACKGROUND

### Technical Field

The present invention relates to an image processing apparatus, an image processing method, and a non-transitory computer readable medium storing an image processing program.

### SUMMARY

According to an aspect of the invention, there is provided an image processing apparatus including: an image receiving unit that receives an image to be encoded; a conversion unit that converts the image received by the image receiving unit; a separation unit that separates the image converted by the conversion unit into pixel synchronization information which is generated in synchronization with pixels forming the image and pixel asynchronization information other than the pixel synchronization information; a first encoding unit that encodes the pixel synchronization information separated by the separation unit; a second encoding unit that encodes the pixel asynchronization information separated by the separation unit; a first decoding unit that decodes a code encoded by the first encoding unit to generate the pixel synchronization information; a second decoding unit that decodes a code encoded by the second encoding unit to generate the pixel asynchronization information; a synthesis unit that synthesizes the pixel synchronization information decoded by the first decoding unit with the pixel asynchronization information decoded by the second decoding unit on the basis of the pixel synchronization information; a reverse conversion unit that performs a conversion process reverse to the conversion process of the conversion unit on information synthesized by the synthesis unit; and an output unit that outputs the image converted by the reverse conversion unit.

### BRIEF DESCRIPTION OF THE DRAWINGS

Exemplary embodiments of the present invention will be described in detail based on the following figures, wherein:

FIG. 1 is a conceptual module configuration diagram illustrating an example of the structure of a first exemplary embodiment;

FIG. 2 is a conceptual module configuration diagram illustrating an example of the structure of a second exemplary embodiment;

FIGS. 3A and 3B are diagrams illustrating an example of an encoding process and a decoding process according to the related art;

FIG. 4 is a diagram illustrating an example of a two-dimensional Huffman code;

FIGS. 5A to 5D are diagrams illustrating the extension of an information source and two-dimensional Huffman coding;

FIG. 6 is a flowchart illustrating an example of a process according to the first exemplary embodiment;

FIG. 7 is a flowchart illustrating an example of a process according to the second exemplary embodiment;

FIGS. 8A and 8B are diagrams illustrating an example of a zero/non-zero pattern;

FIGS. 9A and 9B are diagrams illustrating an example of the 8-order extension of the information source;

FIGS. 10A to 10D are diagrams illustrating an example of the concept of data in the encoding process;

FIGS. 11A and 11B are diagrams illustrating an example of the run representation of the zero/non-zero pattern;

FIGS. 12A to 12D are diagrams illustrating an example of the extension of the information source;

FIG. 13 is a diagram illustrating an example of the concept of an LZ code;

FIG. 14 is a diagram illustrating an example of the processing of the LZ code;

FIGS. 15A to 15D are diagrams illustrating an example of the processing of the LZ code;

FIG. 16 is a graph illustrating the comparison between the processing results of this exemplary embodiment and the related art; and

FIG. 17 is a block diagram illustrating an example of the hardware structure of a computer for implementing this exemplary embodiment.

### DETAILED DESCRIPTION

First, for example, the basic technique of exemplary embodiments of the invention will be described for ease of understanding of the exemplary embodiments.

### <JPEG>

In DCT (Discrete Cosine Transform) in JPEG (Joint Photographic Experts Group), a DCT coefficient, which is one-dimensional information, is decomposed into a non-zero coefficient and a zero run as encoding targets. The non-zero coefficient is information of each pixel and the zero run is information of each run for plural pixels. The non-zero coefficient and the zero run have different processing units.

In JPEG, two information items having different processing units are compressed by so-called two-dimensional Huffman (Huffman) coding. The two-dimensional Huffman coding is a technique that performs variable-length coding on a pair of the zero run and the non-zero coefficient as a symbol to be encoded. In this way, the two information items are integrated into a one-output code.

### <Technique Disclosed in JP-A-2001-119702>

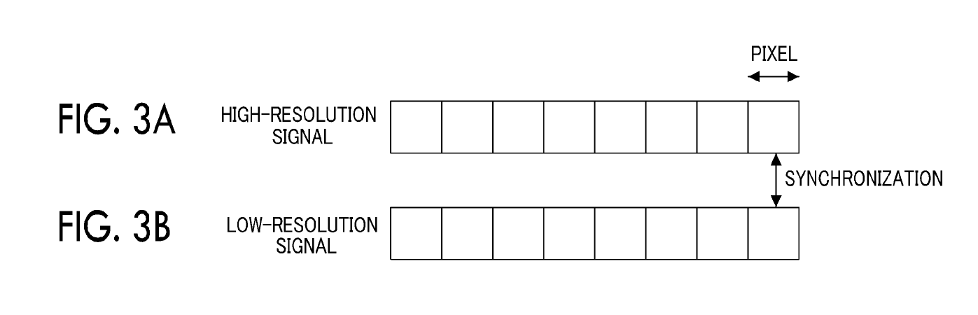

An image (video) is separated into a low-resolution signal and a high-resolution signal (a high-resolution signal shown in FIG. 3A and a low-resolution signal shown in FIG. 3B) and the separated signals are individually encoded. In a decoding process, as shown in FIGS. 3A and 3B, the two signals are decoded in synchronization with pixel accuracy and are combined with each other to obtain a decoded image.

### <Compression by Composite Representation>

In the compression of an image, in some cases, an image is represented by an information group using plural different representation methods. The non-zero coefficient and the zero run in JPEG correspond to this example. Each pixel is converted into a non-zero or zero coefficient. The non-zero coefficient is represented by a scalar, but the zero coefficient is represented by a run.

For the composite representation, JPEG generates a one-dimensional code using the two-dimensional Huffman coding.

In JPEG, the two information items need to form a pair. Therefore, for example, when non-zero coefficients are successive, it is necessary to encode a zero run (length: 0), which is a dummy, which results in an overhead. This is caused by one-dimensionally arranging two information items, such as the non-zero coefficient and the zero run which are not alternately generated.

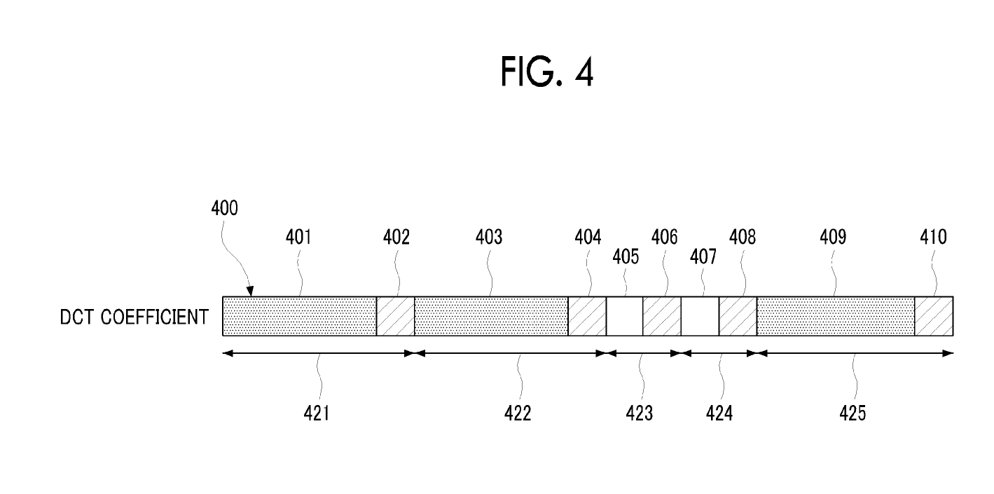

This is shown in FIG. 4 as an example. In this example, a DCT coefficient 400 is generated in the order of a zero run 401, a non-zero coefficient 402, a zero run 403, a non-zero coefficient 404, a non-zero coefficient 406, a non-zero coefficient 408, a zero run 409, and a non-zero coefficient 410. In order to allocate a Huffman code to a pair of the zero run and the non-zero coefficient, a zero run (dummy) 405, which is run 0, is inserted before the non-zero coefficient 406 and a zero run (dummy) 407, which is run 0, is inserted before the non-zero coefficient 408 since the non-zero coefficients 404, 406, and 408 are successive. In this way, the DCT coefficient 400 includes pairs of the zero runs and the non-zero coefficients (a pair of the zero run 401 and the non-zero coefficient 402, a pair of the zero run 403 and the non-zero coefficient 404, a pair of the zero run (dummy) 405, which is run 0, and the non-zero coefficient 406, a pair of the zero run (dummy) 407, which is run 0, and the non-zero coefficient 408, and a pair of the zero run 409 and the non-zero coefficient 410).

### <Extension of Information Source>

In addition, as the encoding technique, there is a theory which arranges plural symbols to reduce the amount of information, thereby expanding an information source. For example, a set of two zero runs is encoded to reduce the number of codes. In this case, the number of zero runs in one set is referred to as an order. For example, when the number of zero runs in one set is two, quadratic extension is performed.

In the case of JPEG, since the zero run and the non-zero need to form a pair, it is difficult to extend the information source. When the information source is forcibly extended, the number of symbols explosively increases, which makes it difficult to mount and design the codes in principle.

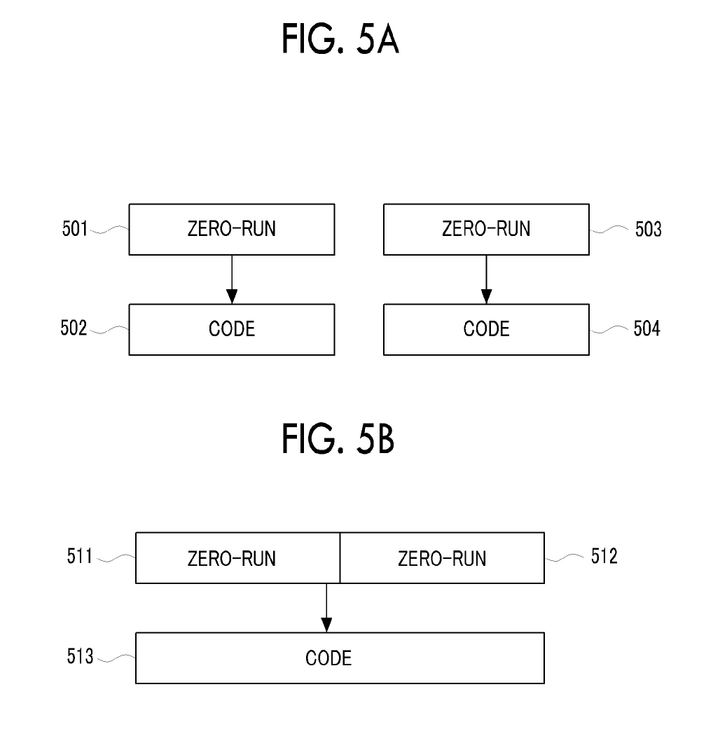

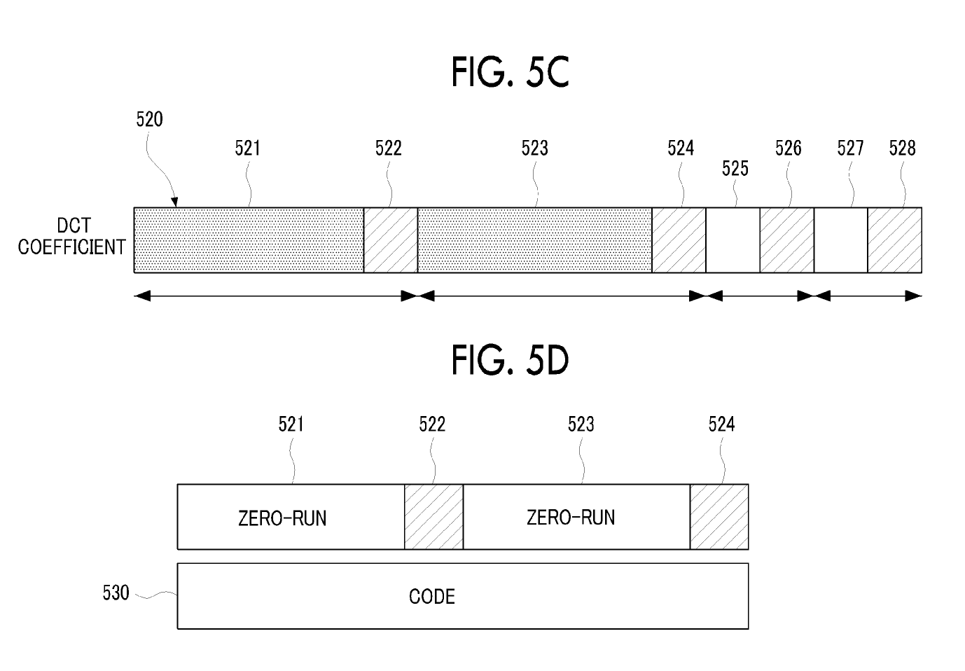

This will be described with reference to FIGS. 5A and 5B. FIG. 5A shows a general encoding process (an encoding process without using the extension of the information source), in which symbols (zero runs 501 and 503 in FIG. 5A) are in one-to-one correspondence with codes (codes 502 and 504 in FIG. 5A). When the extension of the information source is used, as shown in FIG. 5B, N symbols (a zero run 511 and a zero run 512 in FIG. 5B) correspond to one code (a code 513 in FIG. 5B). As shown in FIG. 5C, a DCT coefficient 520 in JPEG includes a zero run 521, a non-zero coefficient 522, a zero run 523, a non-zero coefficient 524, a zero run (dummy) 525, which is run 0, a non-zero coefficient 526, a zero run (dummy) 527, which is run 0, and a non-zero coefficient 528. Since it is premised that a non-zero coefficient spatially follows a zero run, it is difficult to combine a zero run with the next zero run. When this is forcibly extended, that is, when a pair of the zero run and the non-zero coefficient is extended (into a pair of the zero run 521 and the non-zero coefficient 522 and a pair of the zero run 523 and the non-zero coefficient 524 in FIG. 5D) as shown in FIG. 5D, a code table of 160×160=25600 entries is needed and it is difficult to achieve the extension in terms of a size and a principle.

### <Application to Technique Disclosed in JP-A-2001-119702>

As described above, in the case of JPEG, restrictions in the generation of a one-dimensional code (when the non-zero coefficients are successive, the insertion of dummies between the non-zero coefficients) cause an overhead or prevent application to the extension of the information source.

In contrast, the technique disclosed in JP-A-2001-119702 encodes plural information items in parallel. This structure does not have the process of generating the one-dimensional code and there is no restriction in the structure of the code, unlike JPEG.

However, the technique disclosed in JP-A-2001-119702 encodes and decodes two similar information items (a low-resolution signal and a high-resolution signal) in parallel and it is assumed that the same information items are encoded in the same order and the same unit in the technique. Therefore, the technique is not treated by the above-mentioned composite representation (such as a non-zero coefficient and a zero run in JPEG).

Next, exemplary embodiments of the invention will be described with reference to the accompanying drawings.

### First Exemplary Embodiment

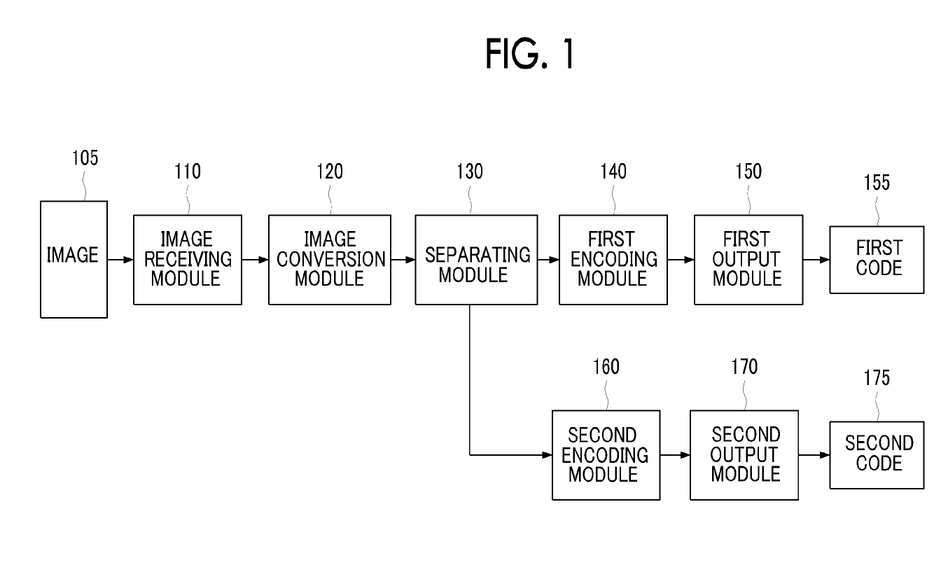

FIG. 1 is a conceptual module configuration diagram illustrating an example of the structure of a first exemplary embodiment (encoding device).

A module generally means a logically separable software (computer program) or hardware component. Therefore, in this exemplary embodiment, the module indicates a module in a hardware structure as well as a module in a computer program. In this exemplary embodiment, a computer program (a program that causes a computer to perform each process, a program that causes a computer to function as each unit, or a program that causes a computer to perform each function) that causes a computer to function as the module, a system, and a method will be described. However, for convenience of explanation, the terms “storing data” and “instructing a unit to store data” and equivalents mean that data is stored in a storage device or control is performed such that data is stored in a storage device when an exemplary embodiment is a computer program. The module may be in one-to-one correspondence with one function. In the mounting of the module, one module may be configured by one program, plural modules may be configured by one program, or one module may be configured by plural programs. In addition, plural modules may be executed by one computer, or one module may be executed by plural computers in a distributed or parallel environment. A module may include another module. In the following description, the term “connection” may include physical connection and logical connection (for example, data communication, instructions, and the reference relationship between data items).

The term “system” or “apparatus” includes a structure in which plural computers, hardware components, and apparatuses are connected to a network (including one-to-one correspondence communication connection) by a communication unit and a structure including one computer, one hardware component, and one apparatus. The “apparatus” and the “system” are used as a synonym. Of course, the “system” does not include a social “structure” (social system), which is an artificial structure.

Whenever each module performs a process or when plural processes are performed in a module, target information is read from a storage device in each process and the processing result is written to the storage device after the process is performed. Therefore, a description of the reading of data from the storage device before a process and the writing of data to the storage device after a process may be omitted. Examples of the storage device may include a hard disk, a RAM (Random Access Memory), an external storage medium, a storage device connected through a communication line, and a register provided in a CPU (Central Processing Unit).

Terms are defined as follows. Among the processing results of an image conversion module 120, information to be output to each pixel is referred to as pixel synchronization information and the other information is referred to as pixel asynchronization information. The pixel synchronization information is generated so as to correspond to the number of pixels, and the generation of the pixel asynchronization information depends on pixels.

In this exemplary embodiment (encoding process), during encoding, an image is compositely represented by plural kinds of information. In this case, the pixel synchronization information is used as first information and the pixel asynchronization information is used as second information. In a decoding process according to a second exemplary embodiment, synchronization control is performed while decoding two kinds of codes, thereby generating necessary information in exact order.

In this exemplary embodiment, information is separated into the pixel synchronization information and the pixel asynchronization information. The independence of two modules that process the pixel synchronization information and the pixel asynchronization information is improved. That is, two modules have flexibility in the structure. In addition, an overhead, such as a dummy in JPEG, is not needed. Since two kinds of information are independently treated, a code table is small and the information source is extended. Therefore, encoding efficiency is improved. Further, an encoding module and a decoding module may be operated in parallel in order to improve a process performance.

The image processing apparatus according to the first exemplary embodiment encodes an image and includes an image receiving module 110, an image conversion module 120, a separation module 130, a first encoding module 140, a first output module 150, a second encoding module 160, and a second output module 170, as shown in FIG. 1.

The image receiving module 110 is connected to the image conversion module 120 and receives an image 105 to be encoded. The reception of the image includes, for example, the reading of an image by a scanner or a camera, the reception of an image by a facsimile from an external apparatus through a communication line, the capture of a video by a CCD (Charge-Coupled Device), and the reading of the image stored in a hard disk (including a hard disk provided in a computer and a hard disk connected to a network). The image may be a binary image or a multi-valued image (including a color image). The number of received images may be one, or two or more. The image may be, for example, a business document or an advertising pamphlet.

The image conversion module 120 is connected to the image receiving module 110 and the separation module 130. The image conversion module 120 converts the image received by the image receiving module 110.

The separation module 130 is connected to the image conversion module 120, the first encoding module 140, and the second encoding module 160. The separation module 130 separates the image converted by the image conversion module 120 into pixel synchronization information which is generated in synchronization with pixels forming the image and pixel asynchronization information other than the pixel synchronization information. Then, the separation module 130 transmits the pixel synchronization information to the first encoding module 140 and transmits the pixel asynchronization information to the second encoding module 160.

For example, the image conversion module 120 and the separation module 130 may be configured as follows.

The image conversion module 120 may perform JPEG frequency conversion and the separation module 130 may separate a zero/non-zero pattern as the pixel synchronization information and separate a non-zero coefficient as the pixel asynchronization information.

The image conversion module 120 may perform conversion using predictive coding and the separation module 130 may separate a zero/non-zero pattern as the pixel synchronization information and separate a non-zero prediction error value as the pixel asynchronization information.

The image conversion module 120 may perform conversion using LZ coding and the separation module 130 may separate match/mismatch information as the pixel synchronization information and separate an appearance position and a pixel value as the pixel asynchronization information.

These examples will be described in detail below.

The first encoding module 140 is connected to the separation module 130 and the first output module 150. The first encoding module 140 encodes the pixel synchronization information separated by the separation module 130. The encoding method is not particularly limited, but it is preferable to use an encoding method suitable for the property of the pixel synchronization signal.

The first output module 150 is connected to the first encoding module 140. The first output module 150 outputs a first code 155 encoded by the first encoding module 140. The first code 155 and a second code 175 output from the second output module 170 are combined with each other and then outputted as the encoding result of the image 105. The term “output” includes, for example, the output of an image to a second image processing apparatus (decoding device), which will be described below, the writing of an image to an image storage device, such as an image database, the storage of an image in a storage medium, such as a memory card, and the transmission of an image to another information processing apparatus.

The second encoding module 160 is connected to the separation module 130 and the second output module 170. The second encoding module 160 encodes the pixel asynchronization information separated by the separation module 130. In some cases, the second encoding module 160 is operated or is not needed to be operated according to pixels. The encoding method is not particularly limited, but it is preferable to use an encoding method suitable for the property of the pixel asynchronization information. The encoding method may be different from that used by the first encoding module 140.

The second output module 170 is connected to the second encoding module 160. The second output module 170 outputs the second code 175 encoded by the second encoding module 160. The second code 175 and the first code 155 output from the first output module 150 are combined with each other and then outputted as the encoding result of the image 105. The term “output” includes, for example, the output of an image to the second image processing apparatus (decoding device), which will be described below, the writing of an image to an image storage device, such as an image database, the storage of an image in a storage medium, such as a memory card, and the transmission of an image to another information processing apparatus.

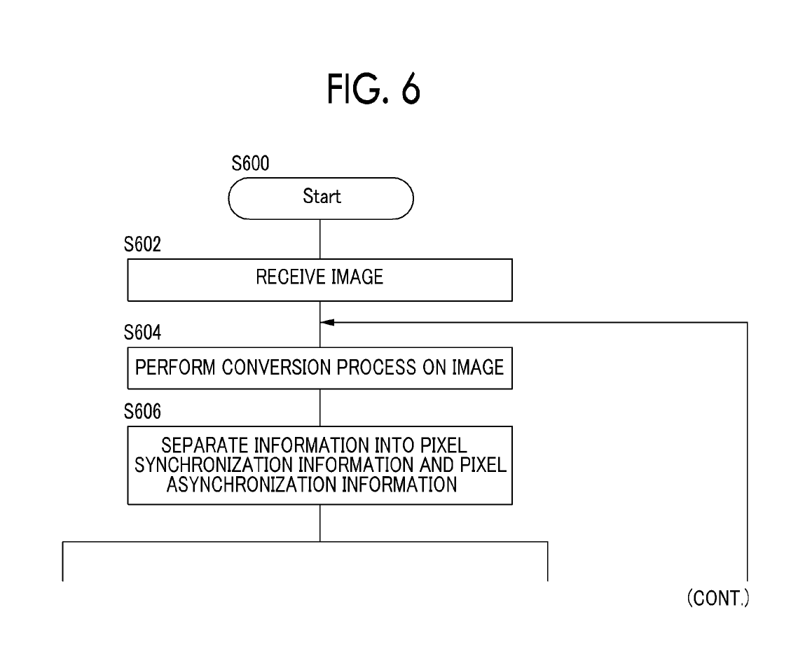

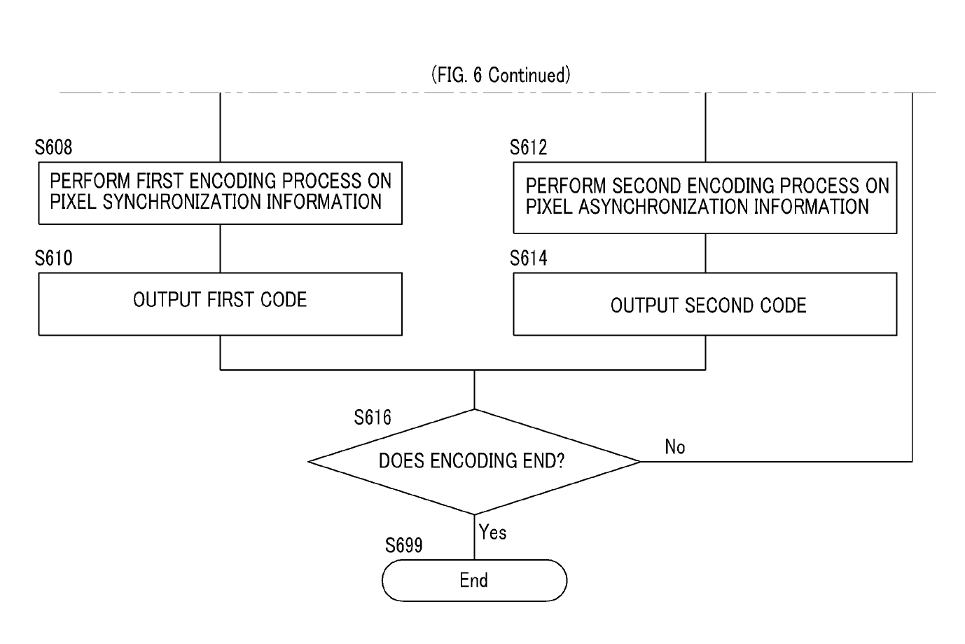

FIG. 6 is a flowchart illustrating an example of the process of the first exemplary embodiment.

In Step S602, the image receiving module 110 receives an image.

In Step S604, the image conversion module 120 converts the image.

In Step S606, the separation module 130 separates the image into pixel synchronization information and pixel asynchronization information. Step S608 and the subsequent steps are performed on the pixel synchronization information and Step S612 and the subsequent steps are performed on the pixel asynchronization information.

In Step S608, the first encoding module 140 performs a first encoding process on the pixel synchronization information.

In Step S610, the first output module 150 outputs the first code 155.

In Step S612, the second encoding module 160 performs a second encoding process on the pixel asynchronization information.

In Step S614, the second output module 170 outputs the second code 175.

In Step S616, it is determined whether the encoding process on the pixels in a target image is completed. When it is determined that the encoding process ends, the process ends (Step S699). If not, the process is performed from Step S604.

The combination of the output results in Steps S610 and S614 is the final encoding result of the image.

### Second Exemplary Embodiment

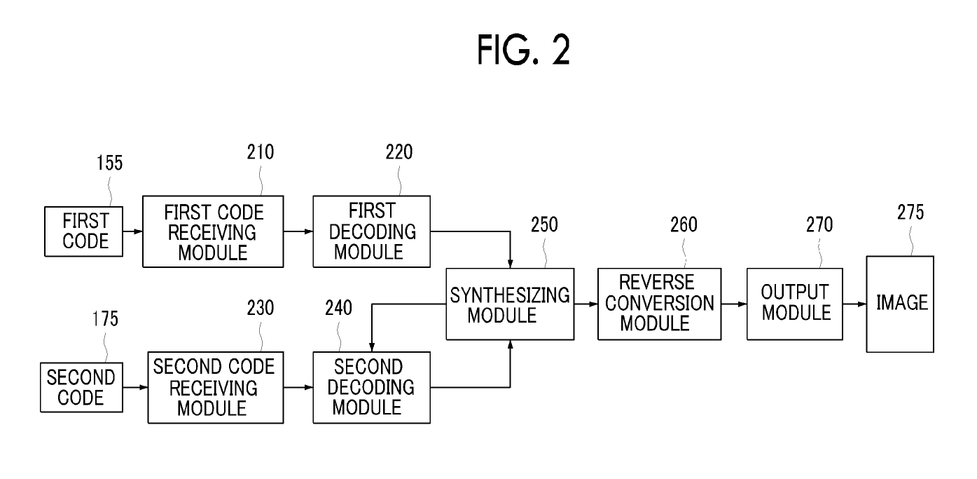

FIG. 2 is a conceptual module configuration diagram illustrating an example of the structure of a second exemplary embodiment (decoding device).

An image processing apparatus according to the second exemplary embodiment decodes an image and includes a first code receiving module 210, a first decoding module 220, a second code receiving module 230, a second decoding module 240, a synthesis module 250, a reverse conversion module 260, and an output module 270, as shown in FIG. 2.

The first code receiving module 210 is connected to the first decoding module 220 and receives the first code 155. The first code 155 is output from the first output module 150 according to the first exemplary embodiment. That is, an image to be encoded is converted, the converted image is separated into pixel synchronization information which is generated in synchronization with pixels forming the image and pixel asynchronization information other than the pixel synchronization information, and the code obtained by encoding the pixel synchronization information is received.

The second code receiving module 230 is connected to the second decoding module 240 and receives the second code 175. The second code 175 is output from the second output module 170 according to the first exemplary embodiment. That is, an image to be encoded is converted, the converted image is separated into pixel synchronization information which is generated in synchronization with pixels forming the image and pixel asynchronization information other than the pixel synchronization information, and the code obtained by encoding the pixel asynchronization information is received. Of course, the received second code 175 corresponds to the first code 155 received by the first code receiving module 210.

The reception of the first code 155 and the second code 175 may include the direct reception of the codes output by the first exemplary embodiment and the reading of the codes from an image storage device, such as an image database, or a storage medium, such as a memory card (including, for example, a storage medium provided in a computer and a storage medium connected through a network), which stores the first code 155 and the second code 175.

The first decoding module 220 is connected to the first code receiving module 210 and the synthesis module 250. The first decoding module 220 decodes the first code 155 received by the first code receiving module 210 and generates the pixel synchronization information. That is, a process reverse to the process of the first encoding module 140 according to the first exemplary embodiment is performed.

The second decoding module 240 is connected to the second code receiving module 230 and the synthesis module 250. The second decoding module 240 decodes the second code 175 received by the second code receiving module 230 and generates the pixel asynchronization information. That is, a process reverse to the process of the second encoding module 160 according to the first exemplary embodiment is performed.

The synthesis module 250 is connected to the first decoding module 220, the second decoding module 240, and the reverse conversion module 260. The synthesis module 250 synthesizes the pixel synchronization information decoded by the first decoding module 220 with the pixel asynchronization information decoded by the second decoding module 240 on the basis of the pixel synchronization information. That is, the synthesis module 250 also performs decoding synchronization control during synthesis. The synthesis module 250 receives the pixel synchronization information output from the first decoding module 220, controls the second decoding module 240 on the basis of the content of the pixel synchronization information, and receives the pixel asynchronization information. Then, the synthesis module 250 transmits the synthesis result of the two information items to the reverse conversion module 260. The term “on the basis of the pixel synchronization information” means that control is performed such that the second decoding module 240 performs a decoding process to receive the pixel asynchronization information when there is non-zero pixel synchronization information among the pixel synchronization information items decoded by the first decoding module 220, which varies depending on the conversion method of the image conversion module 120 according to the first exemplary embodiment. The term “synthesis” means, for example, inserting the pixel asynchronization information into the non-zero pixel synchronization information.

The reverse conversion module 260 is connected to the synthesis module 250 and the output module 270. The reverse conversion module 260 performs a conversion process reverse to the convert process (the conversion process of the image conversion module 120 according to the first exemplary embodiment) performed on the image 105 on the information synthesized by the synthesis module 250.

For example, the first code receiving module 210, the second code receiving module 230, and the reverse conversion module 260 may be configured as follows.

The first code receiving module 210 may receive the code obtained by frequency-converting an image in JPEG and encoding a zero/non-zero pattern as the pixel synchronization information. The second code receiving module 230 may receive the code obtained by frequency-converting an image in JPEG and encoding a non-zero coefficient as the pixel asynchronization information. The reverse conversion module 260 may perform a conversion process reverse to the frequency conversion process in JPEG.

The first code receiving module 210 may receive the code obtained by performing predictive coding on an image and encoding a zero/non-zero pattern as the pixel synchronization information. The second code receiving module 230 may receive the code obtained by performing predictive coding on an image and encoding a non-zero prediction error as the pixel asynchronization information. The reverse conversion module 260 may perform a conversion process reverse to the predictive coding.

The first code receiving module 210 may receive the code obtained by performing LZ coding on an image and encoding match/mismatch information as the pixel synchronization information. The second code receiving module 230 may receive the code obtained by performing LZ coding on an image and encoding an appearance position and a pixel value as the pixel asynchronization information. The reverse conversion module 260 may perform a conversion process reverse to the LZ coding.

These examples will be described in detail below.

The output module 270 is connected to the reverse conversion module 260 and outputs an image 275. The output module 270 outputs the image generated by the conversion process of the reverse conversion module 260. The output of the image includes, for example, the printing of an image by a printing apparatus, such as a printer, the display of an image by a display device, such as a display, the transmission of an image by an image transmitting device, such as a facsimile, the writing of an image to an image storage device, such as an image database, the storage of an image in a storage medium, such as a memory card, and the transmission of an image to another information processing apparatus.

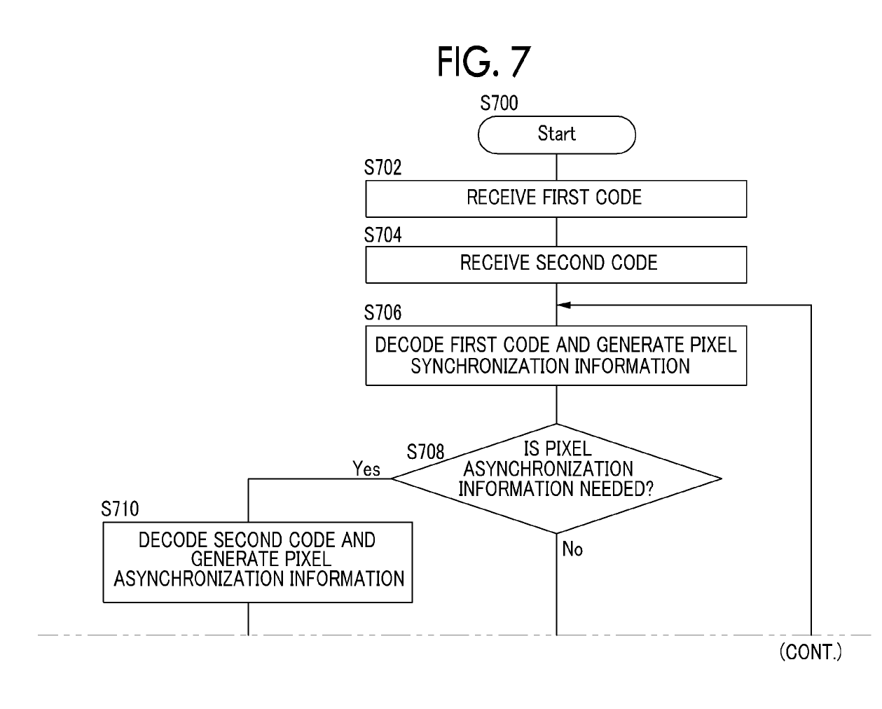

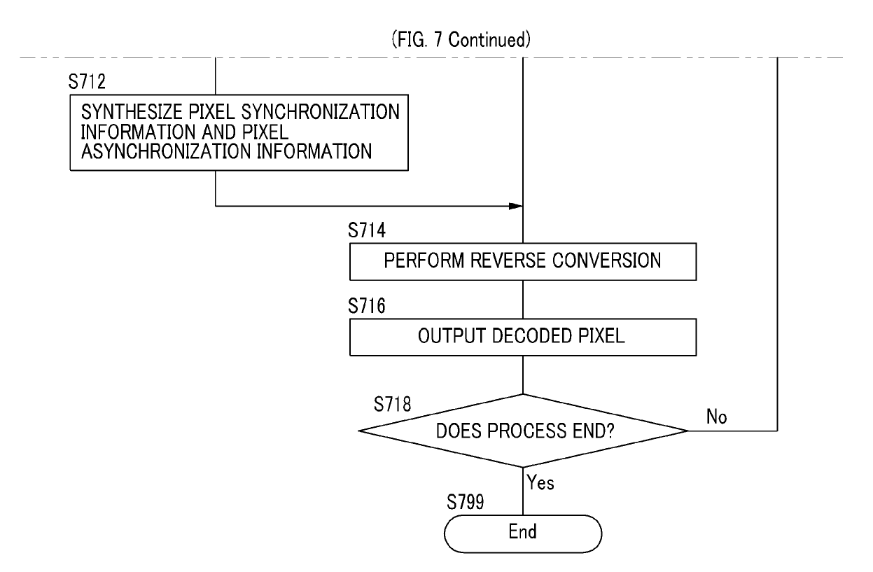

FIG. 7 is a flowchart illustrating an example of the process of the second exemplary embodiment.

In Step S702, the first code receiving module 210 receives the first code 155.

In Step S704, the second code receiving module 230 receives the second code 175.

In Step S706, the first decoding module 220 decodes the first code 155 to generate the pixel synchronization information.

In Step S708, the synthesis module 250 determines whether the pixel asynchronization information is needed. When it is determined that the pixel asynchronization information is needed, the process proceeds to Step S710. If not, the process proceeds to Step S714.

In Step S710, the second decoding module 240 decodes the second code 175 to generate the pixel asynchronization information.

In Step S712, the synthesis module 250 synthesizes the pixel synchronization information with the pixel asynchronization information.

In Step S714, the reverse conversion module 260 performs reverse conversion.

In Step S716, the output module 270 outputs the decoded image.

In Step S718, it is determined whether the output process ends. When it is determined that the output process ends, the process ends (Step S799). If not, the process is performed from Step S706.

The output result in Step S716 is the decoded image.

The process of the first decoding module 220 and the second decoding module 240 may sequentially perform the decoding processes, or the first decoding module 220 and the second decoding module 240 may perform the decoding processes in parallel. As the parallel operation, for example, the second decoding module 240 performs the decoding process in advance as in a pre-reading process and the decoding result is buffered, which is essentially the same as the sequential process.

Next, an example of the processes of the image conversion module 120, the separation module 130, the first encoding module 140, and the second encoding module 160 according to the first exemplary embodiment and an example of the processes of the first code receiving module 210, the second code receiving module 230, the synthesis module 250, and the reverse conversion module 260 according to the second exemplary embodiment will be described.

### <Example of Frequency Conversion in JPEG>

In this example, frequency conversion in JPEG is used in the image conversion module 120, a zero/non-zero pattern is used as the pixel synchronization information instead of the zero run, and a non-zero coefficient is used as the pixel asynchronization information.

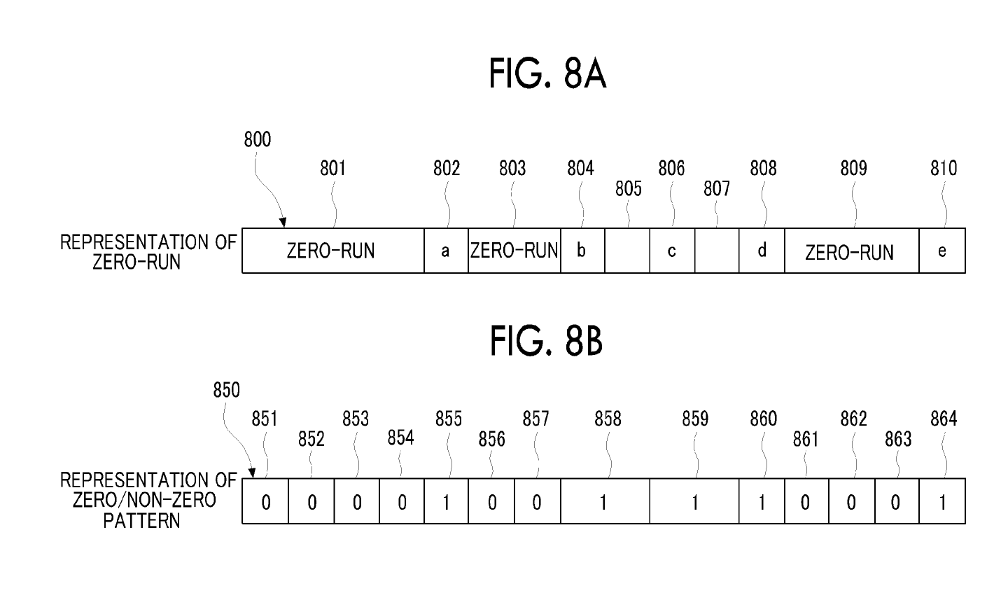

The difference between the zero run and the zero/non-zero pattern will be described below. Since the zero run is generated only for the zero coefficient, it is not the pixel synchronization information. FIGS. 8A and 8B are diagrams illustrating an example of the zero/non-zero pattern.

The zero run representation of a DCT coefficient 800 shown in FIG. 8A has a zero run 801, a non-zero coefficient 802, a zero run 803, a non-zero coefficient 804, a zero run (dummy) 805, which is run 0, a non-zero coefficient 806, a zero run (dummy) 807, which is run 0, a non-zero coefficient 808, a zero run 809, and a non-zero coefficient 810. The image conversion module 120 outputs a DCT coefficient 850 which is represented in a zero/non-zero pattern in FIG. 8B. Specifically, the zero run 801 is represented by four “0s” (zero/non-zero information items 851 to 854), the non-zero coefficient 802 is represented by one “1” (zero/non-zero information 855), the zero run 803 is represented by two “0s” (zero/non-zero information items 856 and 857), the non-zero coefficient 804 and the zero run (dummy) 805, which is run 0, are represented by one “1” (zero/non-zero information 858), the non-zero coefficient 806 and the zero run (dummy) 807, which is run 0, are represented by one “1” (zero/non-zero information 859), the non-zero coefficient 808 is represented by one “1” (zero/non-zero information 860), the zero run 809 is represented by three “0s” (zero/non-zero information items 861 to 863), and the non-zero coefficient 810 is represented by one “1” (zero/non-zero information 864). That is, dummies, such as the zero run (dummy) 805, which is run 0, and the zero run (dummy) 807, which is run 0, are not needed.

In this example, the zero/non-zero pattern is used as the pixel synchronization information and the non-zero coefficient is used as the pixel asynchronization information. Since the zero/non-zero pattern is in a narrow range of [0, 1], it is preferable to extend the information source and then perform encoding. For example, when eight-order extension is performed, a 256-entry code table is prepared.

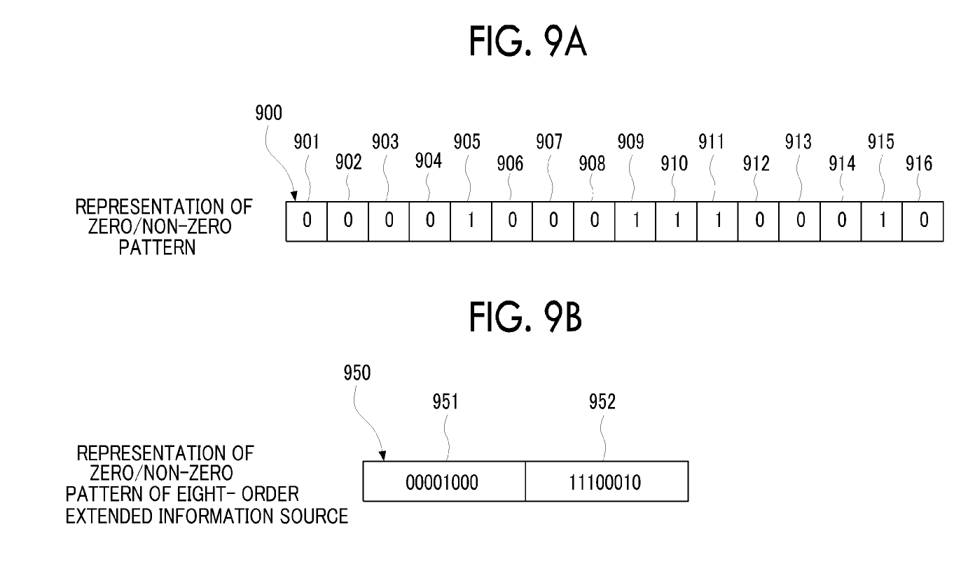

FIGS. 9A and 9B are diagrams illustrating the eight-order extension of the information source. A DCT coefficient 900 represented by a zero/non-zero pattern includes zero/non-zero information items 901 to 916. In contrast, when the eight-order extension of the information source is performed, an information source extension pattern 950 represented by a zero/non-zero pattern includes information source extension pattern information 951 of “00001000” and information source extension pattern information 952 of “11100010”. The first encoding module 140 encodes 8-bit data. That is, a code table including 2̂=256 entries is needed.

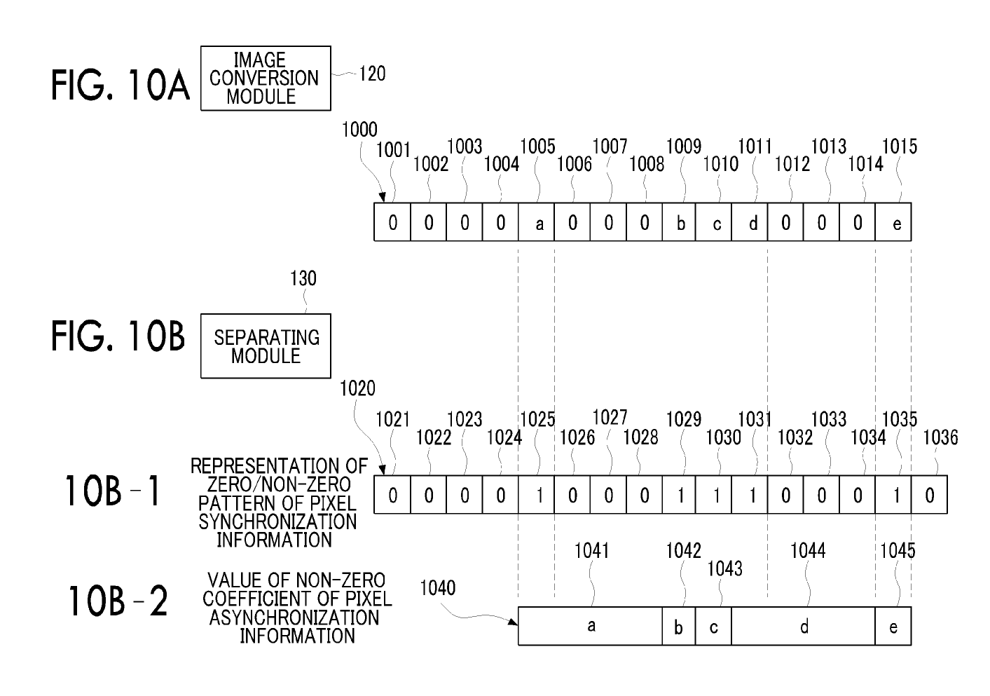

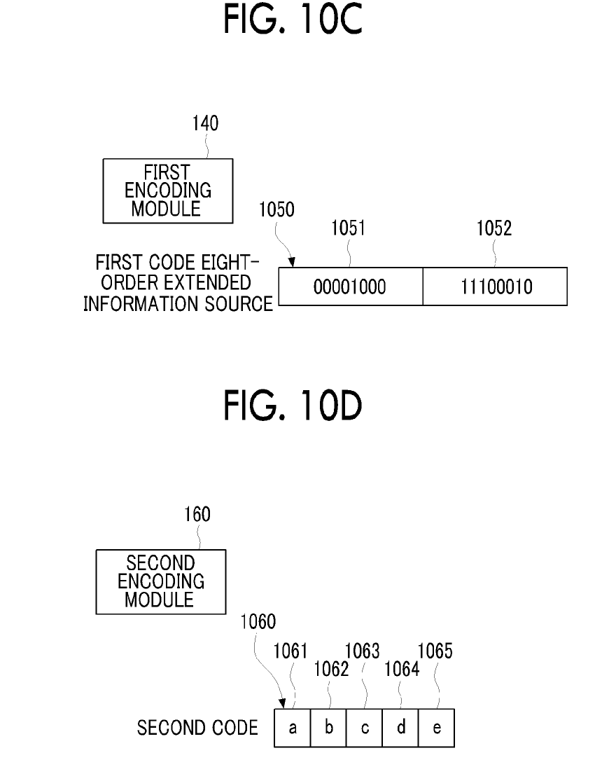

Next, the concept of data will be described. FIGS. 10A to 10D are diagrams illustrating an example of the concept of data in the encoding process.

FIG. 10A shows a conversion result 1000 (DCT coefficient), which is the processing result of the image conversion module 120. The conversion result 1000 includes zero coefficients (1001 to 1004, 1006 to 1008, and 1012 to 1014) and non-zero coefficients (1005, 1009 to 1011, and 1015). The non-zero coefficients may be successive, and a pair of the zero coefficient and the non-zero coefficient is not necessarily generated.

FIG. 10B shows the process of the separation module 130. 10B-1 shows a separation result 1020 which is transmitted to the first encoding module 140 and is a zero/non-zero pattern, which is a pixel synchronization signal. That is, the non-zero coefficient of the conversion result 1000 is “1”, which is 1 bit. 10B-2 shows a separation result 1040 which is transmitted to the second encoding module 160 and is a non-zero coefficient value, which is a pixel asynchronization signal.

FIG. 10C shows a code string 1050, which is the processing result of the first encoding module 140, and the code string 1050 includes information source extension pattern information items 1051 and 1052. The code string 1050 corresponds to the first code 155 and is obtained by the eight-order extension of the information source.

FIG. 10D shows a code string 1060, which is the processing result of the second encoding module 160. The code string 1060 includes coding information items 1061 to 1065 obtained by encoding the separation result 1040. The code string 1060 corresponds to the second code 175.

The image processing apparatus (decoding device) according to the second exemplary embodiment performs a process reverse to the above-mentioned process. That is, the synthesis module 250 generates information corresponding to the output of the image conversion module 120 from the pixel synchronization information and the pixel asynchronization information and the reverse conversion module 260 returns the information to the pixel value. Specifically, the synthesis module 250 controls the decoding of the non-zero coefficient value by the second decoding module 240 on the basis of the zero/non-zero pattern transmitted from the first decoding module 220. That is, the synthesis module 250 outputs 0 when the zero/non-zero pattern is 0 and outputs the non-zero coefficient value decoded by the second decoding module 240 when the zero/non-zero pattern is 1.

The first decoding module 220 is operated for each pixel in principle (except that it decodes a pattern corresponding to the extension of the information source) and the second decoding module 240 is intermittently operated depending on pixels (when 1 is generated in the zero/non-zero pattern).

Next, modifications will be described.

In the above-mentioned structure, the first encoding module 140 may encode the zero/non-zero pattern using an encoding method different from that using the non-zero coefficient value output from the second output module 170, for example, arithmetic coding. In the arithmetic coding, an input is not in one-to-one correspondence with an output. Therefore, the arithmetic coding method is similar to a process in which the information source is extended to all inputs. Thus, in this exemplary embodiment, the arithmetic coding may be applied to a structure in which the zero/non-zero patterns are successive in codes.

In this case, the information source may be extended such that the non-zero coefficient is independent from the zero/non-zero pattern. In JPEG, the non-zero coefficient is entries. Therefore, even when quadratic extension is performed, a code table including 10×10=100 entries is needed.

The information source may be extended over blocks. For example, assuming that the number of coefficients of 8×8 blocks is 64, the zero/non-zero pattern may be extended to 10 units from a request for the size of the code table or the compression ratio, regardless of the number of coefficients.

In addition, run representation, not information source extension, may be applied to the zero/non-zero pattern. In this case, runs may be arranged over the block. Since the run representation includes information indicating the position where the non-zero coefficient, not the zero run, is inserted, it is not necessary to insert the dummy zero run, similarly to the zero/non-zero pattern.

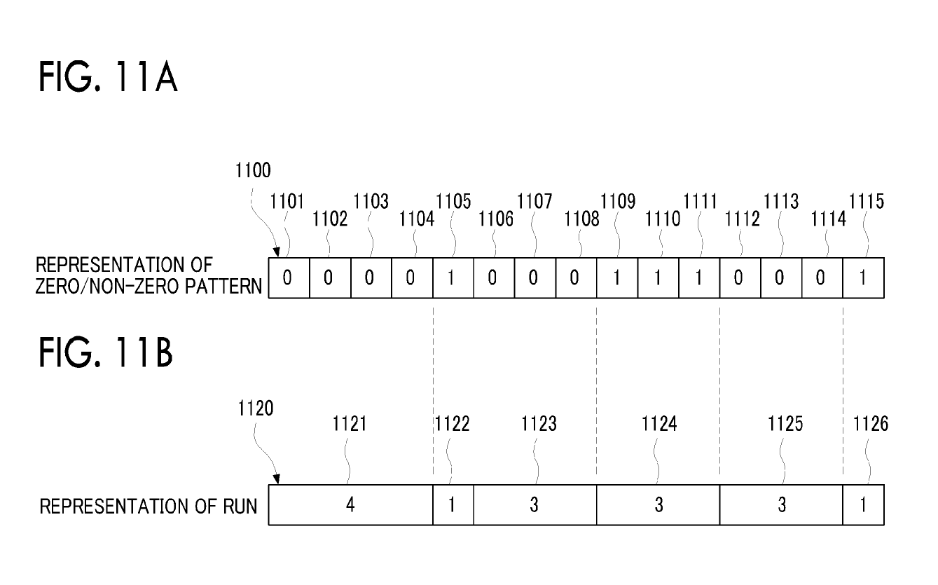

FIGS. 11A and 11B are diagrams illustrating an example of the run representation of the zero/non-zero pattern. FIG. 11A shows a DCT coefficient 1100 in the representation of the zero/non-zero pattern and the DCT coefficient 1100 is to be encoded by the first encoding module 140. In the representation of the zero/non-zero pattern, a dummy is not needed. FIG. 11B shows a run 1120, which is the encoding result of the first encoding module 140 and is the run representation (run coding) of the DCT coefficient 1100. Since runs “0” and “1” alternately appear, information indicating the kind of run (run 0 or 1) may not be included in the run representation.

Since the zero/non-zero pattern is used in this example, information source extension may be applied to one output code. However, in this case, the process becomes complicated. This is because the order in which codes are generated and the order of the codes required for decoding are different between two codes.

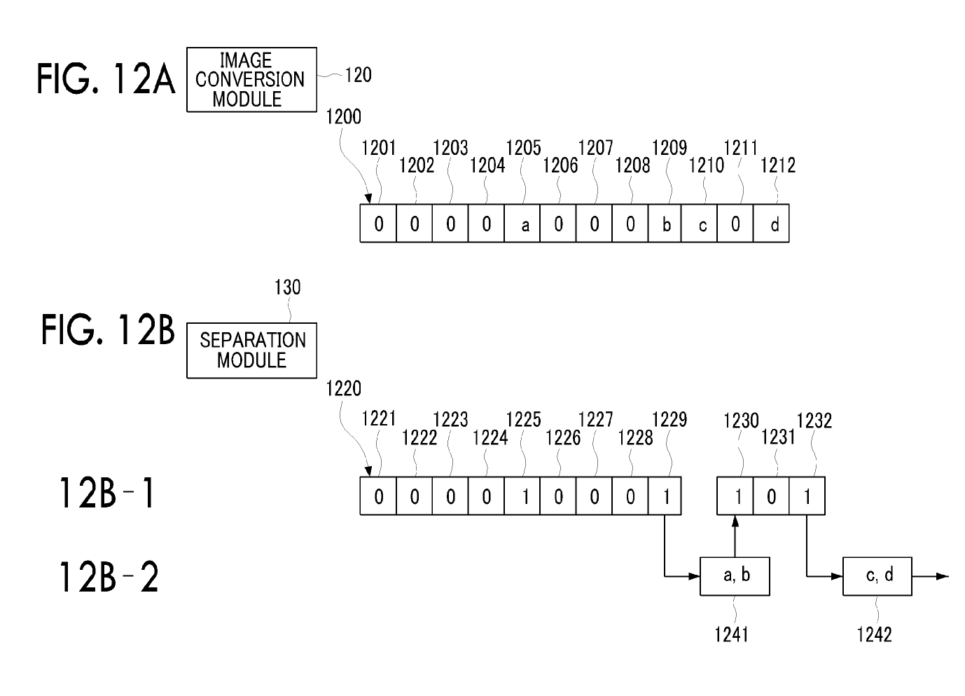

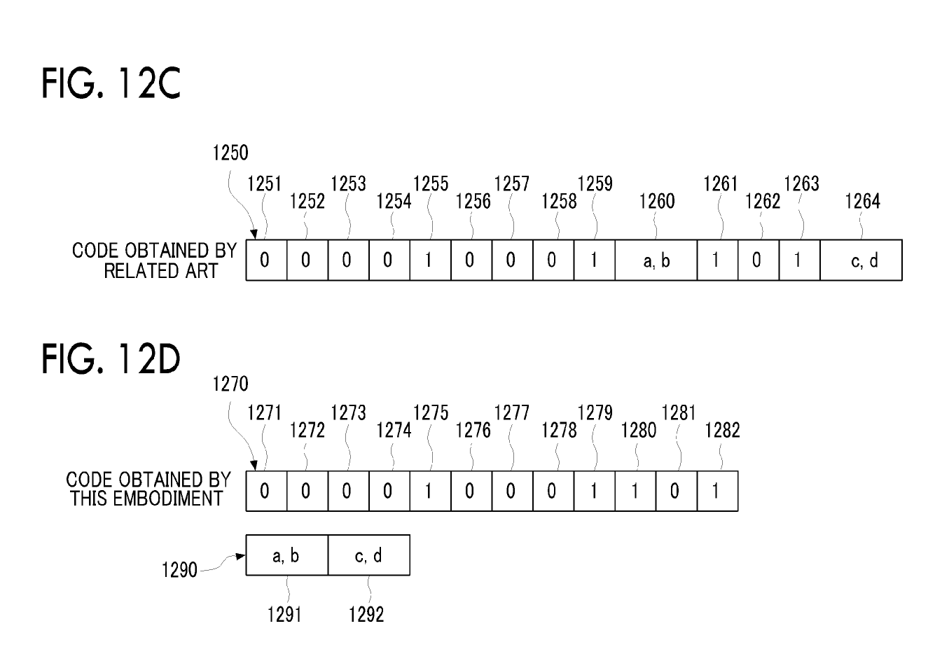

In this exemplary embodiment, since outputs are divided and only the order in each code is stored, the above-mentioned problem does not occur. This will be described with reference to FIGS. 12A to 12D. FIGS. 12A to 12D are diagrams illustrating an example of the extension of the information source.

FIG. 12A shows a conversion result 1200, which is the processing result of the image conversion module 120.

FIG. 12B shows the processing result of the separation module 130. 12B-1 shows a separation result 1220 of the zero/non-zero pattern transmitted to the first encoding module 140 and 12B-2 shows non-zero coefficients 1241 and 1242 transmitted to the second encoding module 160. When two non-zero coefficients are generated, a code is generated. When a second non-zero (zero/non-zero information 1229) is generated, a non-zero coefficient 1241 is transmitted to the second encoding module 160 in order to encode a non-zero coefficient 1205 and a non-zero coefficient 1209 in the conversion result 1200. When the next second non-zero (zero/non-zero information 1232) is generated, a non-zero coefficient 1242 is transmitted to the second encoding module 160 in order to encode a non-zero coefficient 1210 and a non-zero coefficient 1212 in the conversion result 1200.

FIG. 12C shows a code string 1250 encoded by the related art. When the codes are decoded (expanded), zero runs (codes 1256 to 1258) between a code 1255 and a code 1259 need to be expanded and then “a and b” of a code 1260 need to be expanded in order to sequentially perform decoding from the left code.

FIG. 12D shows the processing result of the first encoding module 140 and the processing result of the second encoding module 160 in this exemplary embodiment. When the codes are decoded by the image processing apparatus (decoding device) according to the second exemplary embodiment, the second decoding module 240 decodes a code 1291 of a code string 1290 to obtain “a and b”. Then, the synthesis module 250 may output the decoded non-zero coefficients “a” and “b” when “1” (codes 1275 and 1279) appears in a code string 1270 transmitted from the first decoding module 220.

### <Examples of Conversion by Predictive Coding>

The image conversion module 120 may perform predictive coding as a conversion process. When the predictive coding is applied, for example, the prediction error value of the prediction result may be used to generate a zero run or a zero/non-zero pattern indicating whether an error value is zero or non-zero and, instead of the non-zero coefficient, a non-zero prediction error value may be as a code. The other structures are the same as those in the above-mentioned example.

The zero/non-zero pattern may be a multi-value. For example, plural prediction expressions may be prepared and a value for identifying a prediction expression in which a prediction error is 0 may be inserted at a non-zero position.

### <Examples of Conversion by LZ Coding>

There is LZ coding as a known compression technique. In the LZ coding, there are many variations. In principle, the LZ coding achieves the following: (1) an appearance position where an information string has appeared (including the position of an ID); and (2) a composite representation by two kinds of information of a positive value (a literal and a pixel value) when mismatch occurs.

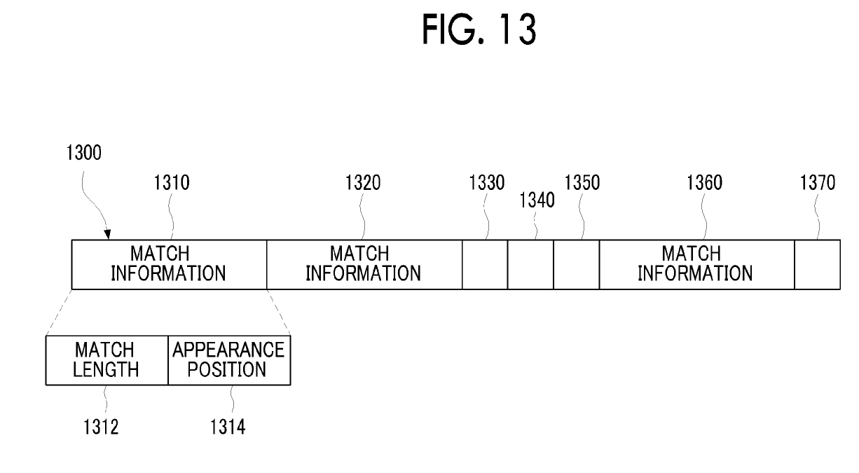

FIG. 13 is a diagram illustrating an example of the concept of an LZ code. An LZ code 1300 includes match information, such as match information 1310, and a literal, such as a literal 1330. The match information 1310 includes a match length 1312 and an appearance position 1314. Match information items, such as the match information items 1310 and 1320, are successive and literals, such as literals 1330, 1340, and 1350 are information of a symbol unit and are successive.

When focusing attention on the structure of a code, match information that is treated as a set of plural symbols and literal information that is treated in a symbol unit are similar to a zero run and a non-zero coefficient in JPEG, respectively. However, the match information items are likely to be successive. Therefore, JPEG pairing is not performed, but different codes in the same code table are allocated to the match length of the match information and the mismatch length of the literal (the number of successive literals) to identify the match information and the literal.

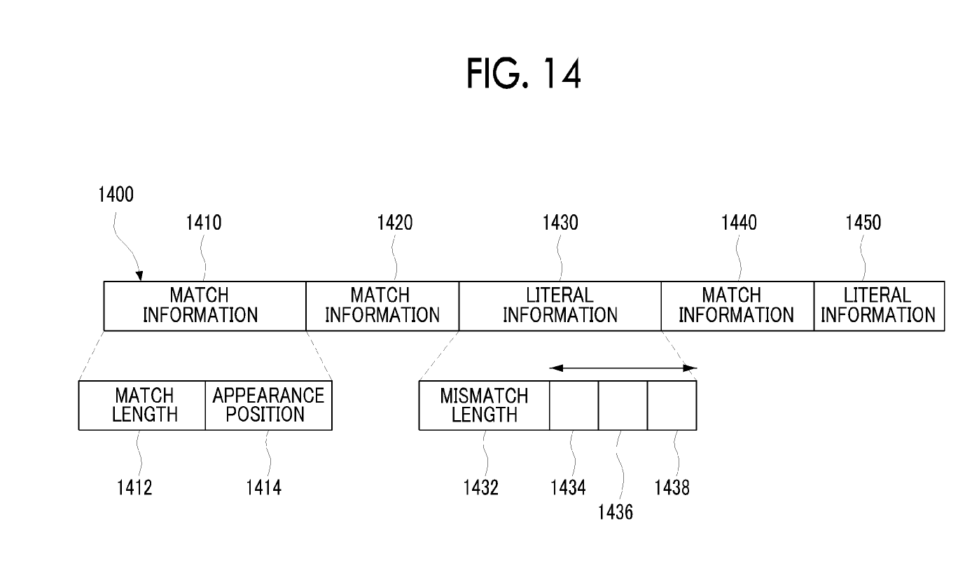

FIG. 14 is a diagram illustrating an example of the processing of the LZ code. An LZ code 1400 includes match information 1410, match information 1420, literal information 1430, match information 1440, and literal information 1450. For example, the match information 1410 includes a match length 1412 and an appearance position 1414. The literal information 1430 includes a mismatch length 1432 and literals 1434, 1436, and 1438. The mismatch length 1432 is 3 since there are the literals 1434, 1436, and 1438. Different codes in the same code table are allocated to the match length and the mismatch length. In this way, it is possible to determine whether information is match information or literal information on the basis of the first code.

When the LZ coding is applied to the image processing apparatus according to this exemplary embodiment, the zero/non-zero pattern is introduced instead of the zero run in the example of the frequency conversion of JPEG. However, here, match/mismatch information is introduced instead of the match information serving as the pixel synchronization information. The match/mismatch information includes the above-mentioned match length and mismatch length. The match length and the mismatch length are representations for pixels, similarly to the run representation. The match length and the mismatch length are less than the number of pixels, but are still information of each pixel. Therefore, the match length and the mismatch length are suitable to define the pixel synchronization information in this exemplary embodiment. In addition, the pixel asynchronization information includes an appearance position and a literal. The two items may be interleaved and may be different code strings.

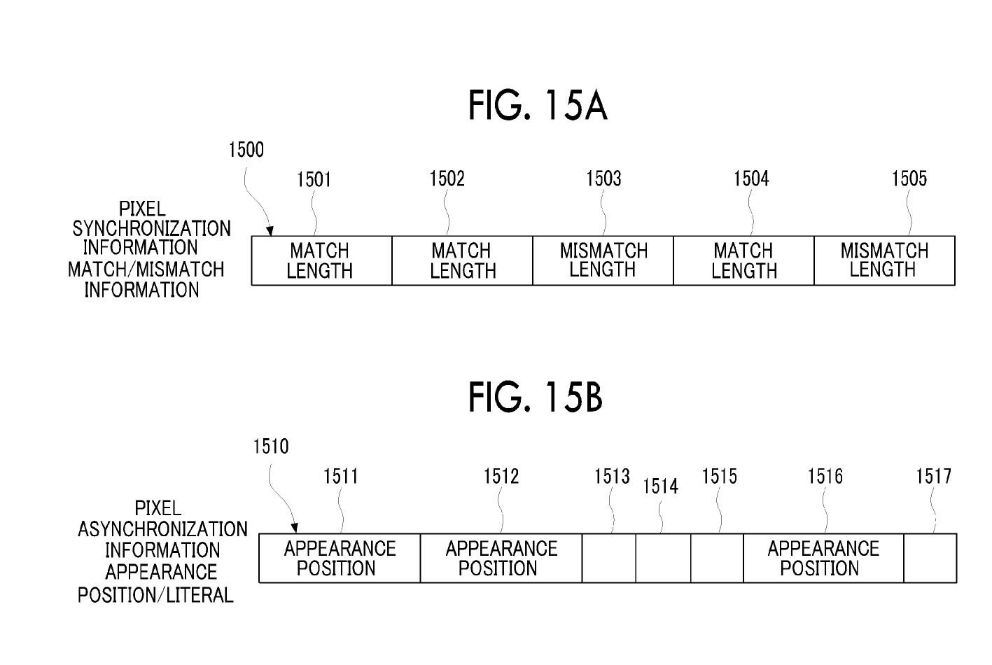

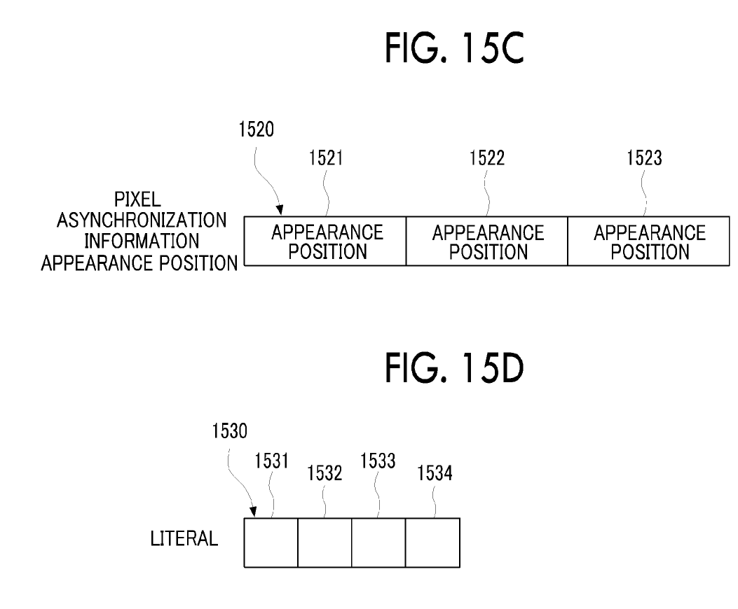

FIGS. 15A to 15C are diagrams illustrating an example of the processing of the LZ code.

FIG. 15A shows the processing result of the image conversion module 120, in which pixel synchronization information 1500, which is match/mismatch information, includes match length information 1501, match length information 1502, mismatch length information 1503, match length information 1504, and mismatch length information 1505.

FIG. 15B shows an example in which the pixel asynchronization information is interleaved. In FIG. 15B, pixel asynchronization information 1510 having appearance positions and literals includes appearance positions 1511, 1512, and 1516 and literals 1513, 1514, 1515, and 1517.

FIGS. 15C and 15D show an example in which pixel asynchronization information has different codes. In FIGS. 15C and 15D, pixel asynchronization information 1520 having appearance positions includes appearance positions 1521, 1522, and 1523. Separately from the pixel asynchronization information 1520, a literal string 1530 includes literals 1531, 1532, 1533, and 1534.

The structure or operation is the same as that in the example of frequency conversion.

### <Experiment Results>

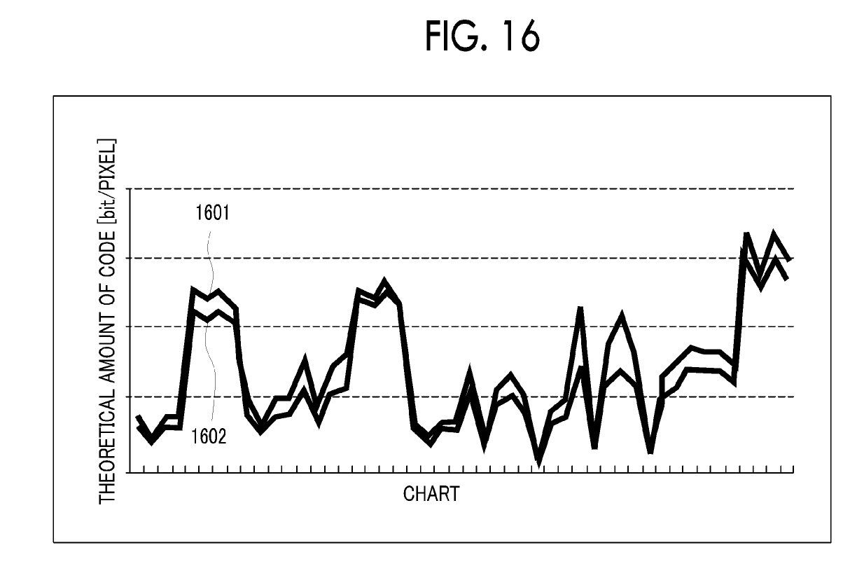

FIG. 16 is a graph illustrating the comparison between the processing results of this exemplary embodiment and the related art. In the graph, the horizontal axis indicates a chart (image 105) and the vertical axis indicates the number of codes (bit/pixel). In this exemplary embodiment, the number of codes indicated by a plot 1602 is less than that indicated by a plot 1601 according to the related art. The plot 1601 according to the related art shows an example in which prediction error information is represented by a zero/non-zero pattern and a non-zero prediction error value in predictive coding using an immediately left difference (difference from a pixel adjacent on the left side). Information source extension is individually performed on the zero/non-zero pattern and the non-zero prediction error value.

The following encoding module may be used as the image conversion module 120 according to the first exemplary embodiment when predictive coding is applied:

According to a first aspect, there is provided an encoding module including: a group generating module that arranges plural encoding target information items to generate encoding target information groups; a code allocating module that allocates codes to the groups generated by the group generating module; and an encoding target information encoding module that encodes the encoding target information in each group with the code allocated to each group.

According to a second aspect, the encoding module according to the first aspect further includes a group classifying module. The group generating module arranges the plural encoding target information items to generate low-order groups including the encoding target information items and the group classifying module classifies the low-order groups generated by the group generating module into high-order groups. The code allocating module allocates the codes to the high-order groups. The encoding target information encoding module encodes the encoding target information in the low-order groups belonging to the same high-order group using a variable-length code allocated to the high-order group.

According to a third aspect, in the encoding module according to the second aspect, the group generating module arranges plural input encoding target information items in an input order to generate low-order groups each having a predetermined number of encoding target information items. The group classifying module classifies the low-order groups into the high-order groups on the basis of the number of bits for implementing the encoding target information in the low-order group.

According to a fourth aspect, in the encoding module according to the first aspect, the code allocating module allocates an entropy code to each group according to the probability of occurrence of each group.

According to a fifth aspect, the encoding module according to the first aspect further includes an encoding target information conversion module that converts input encoding target information into a bit string which is represented by the number of bits less than that of the encoding target information. The encoding target information encoding module encodes the encoding target information in each group using the bit string converted by the encoding target information conversion module and the codes allocated to the groups.

According to a sixth aspect, the encoding module according to the first aspect further includes: a table utilization encoding module that encodes the group of the encoding target information using a code table in which plural encoding target information items in the group are associated with code data of the encoding target information items; and an allocating module that allocates the group of the encoding target information generated by the group generating module to a set of the code allocating module and the encoding target information encoding module, or the table utilization encoding module. The code allocating module allocates a code to the group allocated by the allocating module and the encoding target information encoding module encodes the encoding target information in the group allocated by the allocating module.

The reverse conversion module 260 corresponding to the encoding module according to any one of the first to sixth aspects has a structure according to the following seventh aspect.

According to the seventh aspect, there is provided a decoding module including: a code length specifying module that specifies the code length of encoding target information in a group on the basis of a code allocated to the group including plural encoding target information items; and an encoding target information decoding module that decodes the encoding target information in the group on the basis of the code length of each encoding target information item specified by the code length specifying module.

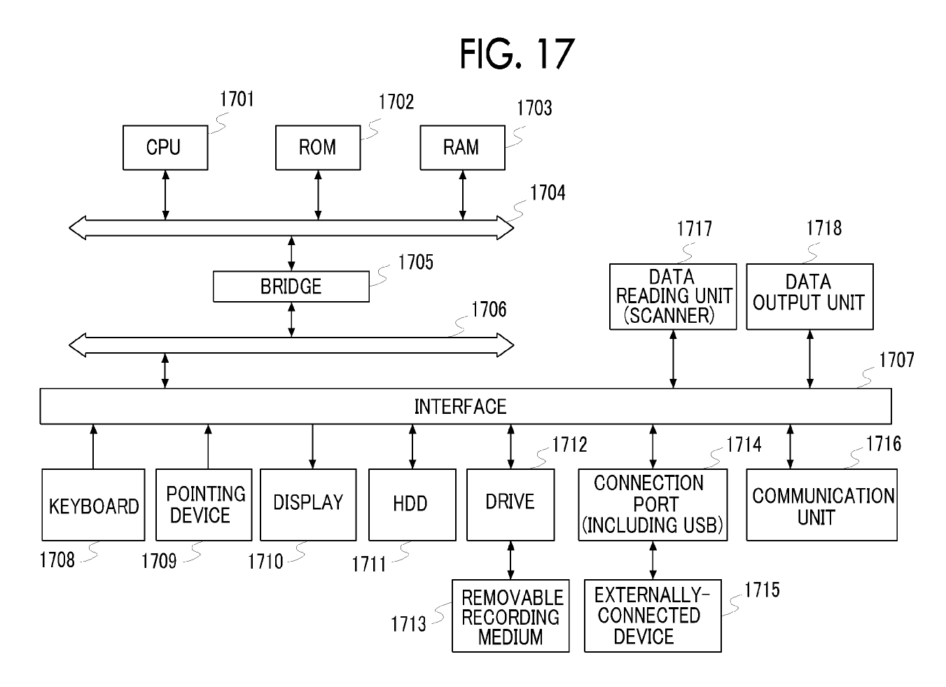

Next, an example of the hardware structure of the image processing apparatus according to this exemplary embodiment will be described with reference to FIG. 17. FIG. 17 shows, for example, the hardware structure of a personal computer (PC) including a data reading unit 1717, such as a scanner, and a data output unit 1718, such as a printer.

A CPU (Central Processing Unit) 1701 is a controller that performs a process according to a computer program describing the execution sequence of each module which is described in the above-described exemplary embodiment, that is, the image conversion module 120, the separation module 130, the first encoding module 140, the second encoding module 160, the first decoding module 220, the second decoding module 240, the synthesis module 250, and the reverse conversion module 260.

A ROM (Read Only Memory) 1702 stores programs or operation parameters used by the CPU 1701. A RAM (Random Access Memory) 1703 stores, for example, programs executed by the CPU 1701 and parameters which are appropriately changed in the execution of the programs. The units are connected to each other by a host bus 1704, such as a CPU bus.

The host bus 1704 is connected to an external bus 1706, such as a PCI (Peripheral Component Interconnect/Interface) bus through a bridge 1705.

A keyboard 1708 and a pointing device 1709, such as a mouse, are input devices operated by the operator. A display 1710 is, for example, a liquid crystal display device or a CRT (Cathode Ray Tube) and displays various kinds of information as text or image information.

An HDD (Hard Disk Drive) 1711 includes a hard disk provided therein and drives a hard disk to record or reproduce information and the programs executed by the CPU 1701. The hard disk stores, for example, the received images, codes, which are the results of the encoding process, and the decoded images. In addition, the hard disk stores various kinds of computer programs, such as data processing programs.

A drive 1712 reads data or programs recorded on a removable recording medium 1713 inserted thereinto, such as a magnetic disk, an optical disk, a magneto-optical disk, or a semiconductor memory, and supplies the read data or programs to the RAM 1703 connected thereto through an interface 1707, the external bus 1706, the bridge 1705, and the host bus 1704. The removable recording medium 1713 may be used as a data recording region, similarly to the hard disk.

A connection port 1714 is connected to an externally-connected device 1715 and includes a connection portion, such as USB or IEEE1394. The connection port 1714 is connected to, for example, the CPU 1701 through the interface 1707, the external bus 1706, the bridge 1705, and the host bus 1704. A communication unit 1716 is connected to a network and performs data communication with the outside. A data reading unit 1717 is for example, a scanner and reads a document. A data output unit 1718 is, for example, a printer and outputs document data.

The hardware structure of the image processing apparatus shown in FIG. 17 is an illustrative example and this exemplary embodiment is not limited to the structure shown in FIG. 17. The image processing apparatus may have any structure as long as it may implement the functions of the modules described in this exemplary embodiment. For example, some modules may be configured by dedicated hardware (for example, an application specific integrated circuit: ASIC), and some modules may be provided in an external system and then connected to the image processing apparatus through a communication line. In addition, plural systems shown in FIG. 17 may be connected to each other by the communication line so as to be cooperatively operated. For example, the image processing apparatus may be incorporated into a copier, a facsimile, a scanner, a printer, and a multi-function machine (an image processing apparatus having two or more of the functions of a scanner, a printer, a copier, and a facsimile).

The above-described exemplary embodiments may be combined with each other (for example, including the addition and replacement of the modules in a given exemplary embodiment to and with the modules in another exemplary embodiment) and the technique described in the related art may be used as the content of the process of each module. The first exemplary embodiment and the second exemplary embodiment may be combined with each other as follows: the first code receiving module 210 receives the first code 155 output from the first output module 150, the second code receiving module 230 receives the second code 175 output from the second output module 170, the first decoding module 220 decodes the encoding result of the first encoding module 140, and the second decoding module 240 decodes the encoding result of the second encoding module 160.

The above-mentioned program may be stored in a recording medium and then provided. In addition, the program may be provided by the communication unit. In this case, for example, the above-mentioned program may be understood as a “computer readable recording medium storing a program”.

The “computer readable recording medium storing a program” means a computer readable recording medium having a program recorded thereon which is used to install, execute, and distribute the program.

Examples of the recording medium include digital versatile disks (DVDs) defined by the DVD forum, such as “DVD-R, DVD-RW, and DVD-RAM”, DVDs defined by DVD+RW, such as “DVD+R and DVD+RW”, compact disks (CDs), such as a CD read only memory (CD-ROM), CD recordable (CD-R), and CD rewritable (CD-RW), a Blu-ray disc (registered trademark), a magneto-optical disk (MO), a flexible disk (FD), a magnetic tape, a hard disk, a read only memory (ROM), an electrically erasable programmable read only memory (EEPROM (registered trademark)), a flash memory, and a random access memory (RAM).

The program or a portion thereof may be recorded on the recording medium and then held or distributed. In addition, the program may be transmitted through a transmission medium, such as a wired network used in, for example, a local area network (LAN), a metropolitan area network (MAN), a wide area network (WAN), the Internet, an intranet, and an extranet, a wireless communication network, or a combination thereof. Alternatively, the program may be transmitted on carrier waves.

The program may be a portion of another program, or it may be recorded on a recording medium together with a separate program. The program may be separately recorded on plural recording media. The program may be recorded in any form as long as it may be, for example, compressed or encoded.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image processing apparatus comprising:
an image receiving unit that receives an image to be encoded;
a conversion unit that converts the image received by the image receiving unit;
a separation unit that separates the image converted by the conversion unit into pixel synchronization information which is generated in synchronization with pixels forming the image and pixel asynchronization information other than the pixel synchronization information;
a first encoding unit that encodes the pixel synchronization information separated by the separation unit;
a second encoding unit that encodes the pixel asynchronization information separated by the separation unit;
a first decoding unit that decodes a code encoded by the first encoding unit to generate the pixel synchronization information;
a second decoding unit that decodes a code encoded by the second encoding unit to generate the pixel asynchronization information;
a synthesis unit that synthesizes the pixel synchronization information decoded by the first decoding unit with the pixel asynchronization information decoded by the second decoding unit on the basis of the pixel synchronization information;
a reverse conversion unit that performs a conversion process reverse to the conversion process of the conversion unit on information synthesized by the synthesis unit; and
an output unit that outputs the image converted by the reverse conversion unit.

2. An image processing apparatus comprising:
an image receiving unit that receives an image to be encoded;
a conversion unit that converts the image received by the image receiving unit;
a separation unit that separates the image converted by the conversion unit into pixel synchronization information which is generated in synchronization with pixels forming the image and pixel asynchronization information other than the pixel synchronization information;
a first encoding unit that encodes the pixel synchronization information separated by the separation unit;
a second encoding unit that encodes the pixel asynchronization information separated by the separation unit;
a first output unit that outputs a code encoded by the first encoding unit; and
a second output unit that outputs a code encoded by the second encoding unit.

3. The image processing apparatus according to claim 2,
wherein the conversion unit performs frequency conversion in JPEG, and
the separation unit separates a zero/non-zero pattern as the pixel synchronization information and separates a non-zero coefficient as the pixel asynchronization information.

4. The image processing apparatus according to claim 2,
wherein the conversion unit performs conversion using predictive coding, and
the separation unit separates a zero/non-zero pattern as the pixel synchronization information and separates a non-zero prediction error value as the pixel asynchronization information.

5. The image processing apparatus according to claim 2,
wherein the conversion unit performs conversion using LZ coding, and
the separation unit separates match/mismatch information as the pixel synchronization information and separates an appearance position and a pixel value as the pixel asynchronization information.

6. An image processing apparatus comprising:
a first receiving unit that receives a code obtained by encoding pixel synchronization information which is generated in synchronization with pixels forming a converted image to be encoded, the image being separated into the pixel synchronization information and pixel asynchronization information other than the pixel synchronization information;
a second receiving unit that receives a code obtained by encoding the pixel asynchronization information;
a first decoding unit that decodes the code received by the first receiving unit to generate the pixel synchronization information;
a second decoding unit that decodes the code received by the second receiving unit to generate the pixel asynchronization information;
a synthesis unit that synthesizes the pixel synchronization information decoded by the first decoding unit with the pixel asynchronization information decoded by the second decoding unit on the basis of the pixel synchronization information;
a reverse conversion unit that performs a conversion process reverse to the conversion process which is performed on the image on information synthesized by the synthesis unit; and
an output unit that outputs the image generated by the conversion process of the reverse conversion unit.

7. The image processing apparatus according to claim 6,
wherein the first receiving unit receives a code obtained by performing frequency conversion in JPEG on an image and encoding a zero/non-zero pattern as the pixel synchronization information,
the second receiving unit receives a code obtained by performing the frequency conversion in JPEG on an image and encoding a non-zero coefficient as the pixel asynchronization information, and
the reverse conversion unit performs a conversion process reverse to the frequency conversion in JPEG.

8. The image processing apparatus according to claim 6,
wherein the first receiving unit receives a code obtained by performing predictive coding on an image and encoding a zero/non-zero pattern as the pixel synchronization information,
the second receiving unit receives a code obtained by performing the predictive coding on an image and encoding a non-zero prediction error as the pixel synchronization information, and
the reverse conversion unit performs a conversion process reverse to the predictive coding.

9. The image processing apparatus according to claim 6,
wherein the first receiving unit receives a code obtained by performing LZ coding on an image and encoding match/mismatch information as the pixel synchronization information,
the second receiving unit receives a code obtained by performing the LZ coding on an image and encoding an appearance position and a pixel value as the pixel synchronization information, and
the reverse conversion unit performs a conversion process reverse to the LZ coding.

10. An image processing method comprising:
receiving an image to be encoded;
converting the received image;
separating the converted image into pixel synchronization information which is generated in synchronization with pixels forming the image and pixel asynchronization information other than the pixel synchronization information;
encoding the separated pixel synchronization information;
encoding the separated pixel asynchronization information; and
outputting encoded codes.

11. An image processing method comprising:
receiving a code obtained by encoding pixel synchronization information which is generated in synchronization with pixels forming an image to be encoded, the image being separated into the pixel synchronization information and pixel asynchronization information other than the pixel synchronization information;
receiving a code obtained by encoding the pixel asynchronization information;
decoding the received code to generate the pixel synchronization information;
decoding the received code to generate the pixel asynchronization information;
synthesizing the decoded pixel synchronization information with the decoded pixel asynchronization information on the basis of the decoded pixel synchronization information;
performing a conversion process reverse to the conversion process, which is performed on the image, on the synthesized information; and
outputting the image generated by the conversion process.

12. A non-transitory computer readable medium storing an image processing program that causes a computer to function as:
an image receiving unit that receives an image to be encoded;
a conversion unit that converts the image received by the image receiving unit;
a separation unit that separates the image converted by the conversion unit into pixel synchronization information which is generated in synchronization with pixels forming the image and pixel asynchronization information other than the pixel synchronization information;
a first encoding unit that encodes the pixel synchronization information separated by the separation unit;
a second encoding unit that encodes the pixel asynchronization information separated by the separation unit;
a first output unit that outputs a code encoded by the first encoding unit; and
a second output unit that outputs a code encoded by the second encoding unit.

13. A non-transitory computer readable medium storing an image processing program that causes a computer to function as:
a first receiving unit that receives a code obtained by encoding pixel synchronization information which is generated in synchronization with pixels forming a converted image to be encoded, the image being separated into the pixel synchronization information and pixel asynchronization information other than the pixel synchronization information;
a second receiving unit that receives a code obtained by encoding the pixel asynchronization information;
a first decoding unit that decodes the code received by the first receiving unit to generate the pixel synchronization information;
a second decoding unit that decodes the code received by the second receiving unit to generate the pixel asynchronization information;
a synthesis unit that synthesizes the pixel synchronization information decoded by the first decoding unit with the pixel asynchronization information decoded by the second decoding unit on the basis of the pixel synchronization information;
a reverse conversion unit that performs a conversion process reverse to the conversion process, which is performed on the image, on information synthesized by the synthesis unit; and
an output unit that outputs the image generated by the conversion process of the reverse conversion unit.
